(19) United States
(12) Patent Application Publication
(10) Pub. No.: US 2005/0253538 A1
(43) Pub. Date: Nov. 17, 2005

(54) Remotely controlled lighting system and controller switch for operation on same

(76) Inventors: Suresh Shah, Thane (IN); Barton A. Pastemak, Elkins Park, PA (US); Dipesh M. Pandya, Bensalem, PA (US)

Correspondence Address: Joseph R. DelMaster, Jr., Esquire;Drinker Biddle & Reath LLP, Suite 1100, 1500 K Street N.W., Washington, DC, 20005, US

(21) Appl. No.: 11/092,092

(22) Filed: Mar. 29, 2005

Related U.S. Application Data
(60) Provisional application No. 60/557,717, filed on Mar. 29, 2004.

(51) Int. Cl. H05B 37/02

(52) U.S. Cl. 315/362

(57) ABSTRACT

A system for controlling lighting environment, comprising a lighting fixture, a control switch coupled to the fixture, and a communications link between the control switch and a user interface, wherein a user can control a light intensity of a lighting fixture via commands entered into the user interface.

### RELATED APPLICATION

The present application claims priority to provisional application No. 60/557,717 filed on Mar. 29, 2004.

### FIELD OF THE INVENTION

The invention relates to the field of lighting control, and more specifically, to a new and useful system for remotely controlling lighting control devices using a novel controller switch.

### Background of the Invention

Lighting control switches, commonly referred to as dimmer switches, are popular devices used to create desirable levels of illumination in a particular area. All of the lighting fixtures in a room can be coupled to a single lighting control switch, or alternatively, a single fixture or group of lighting fixtures may each have its own control switch. The use of lighting control switches allow for precise lighting intensity of one or more lighting fixtures in a particular area.

Prior art lighting control switches were constructed by simply incorporating a variable resister into the switch. These devices were used in conjunction with incandescent lighting fixtures. These switches allowed the user to vary the voltage to the light, usually by rotating a dial, and thus alter the light intensity level.

Subsequently developed lighting control switches utilized solid-state circuitry to improve upon the features of a variable resister type switch. These newer switches allowed for discrete jumps in light levels (e.g., from one level to a different level without cycling through all light intensities in between). Additionally, improved lighting control switches often included additional circuitry capable of remembering pre-programmed light levels (i.e., the control switch contained a memory module).

Both the simple variable resister switches and the more advanced solid-state switches required user intervention at the switch location to operate. In other words, a user had to adjust the switch in order to effect a change in lighting conditions. This can be inconvenient in a large facility containing may switch locations, or in situations where the user is not physically near the building where the switches are used. For example, a homeowner may desire to dim or extinguish lights that he or she may have forgotten to adjust before leaving home for the office.

A need exists for a lighting control switch that can be controlled both locally and remotely. Additionally, a need exists for a system to provide such control. This invention fulfils these needs, among others.

### SUMMARY OF THE INVENTION

A lighting control switch is provided that has a simple two wire configuration for controlling an amount of power supplied through a load. The switch may operate using a pulse width modulation technique to achieve liner dimming of inductive or non-inductive loads. Additionally, the switch in accordance with an exemplary embodiment of the present invention is capable of receiving control instructions via various input mechanisms and can control a lighting fixture in response to the received control instructions. Additionally, a system is provided for allowing a user to control the lighting fixture from a remote location via a communications link to the control switch.

In an exemplary implementation, the system includes a user interface to allow a user to select desired lighting conditions, a web service operating on a server to communicate a signal representative of the user selections via the internet to a local transceiver capable of relaying the signal to the control switch. The system may further include a wireless communications link for remote transmission of the signal from server to the local transceiver.

### BRIEF DESCRIPTION OF THE DRAWINGS

For the purpose of illustrating the invention, there is shown in the drawings a form which is presently preferred; it being understood, that this invention is not limited to the precise arrangements and instrumentalities shown.

FIG. 1 a block diagram of a system for lighting control in accordance with an exemplary embodiment of the present invention.

FIG. 2 is a block diagram of an exemplary embodiment of a lighting control switch capable of operating in conjunction with the system as shown in FIG. 1.

FIG. 3 is a flow chart of the process used to control a lighting fixture in accordance with an exemplary embodiment of the present invention.

FIG. 4 is a schematic drawing of an exemplary implementation of the control switch.

### DETAILED DESCRIPTION OF THE DRAWINGS

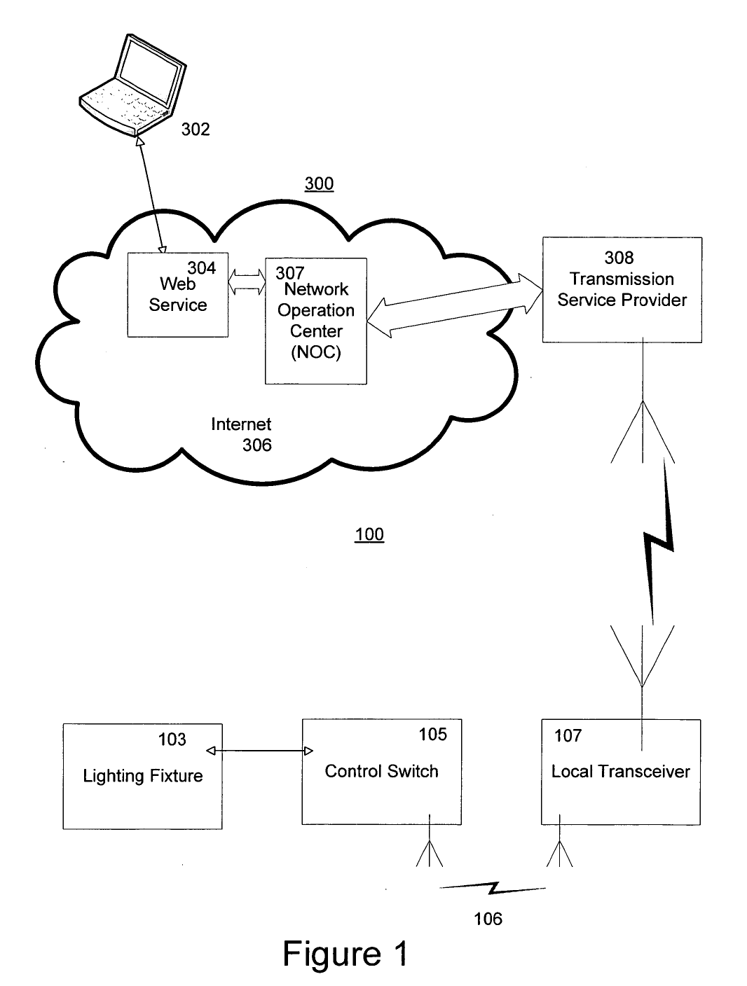

Referring to FIG. 1, an exemplary embodiment of the system 100 in accordance with the present invention is illustrated. One or more lighting fixtures 103 reside within the system and are the subject control by the end user. These lighting fixtures may include large lighting mechanisms, such as a grid of many individual light bulbs in a warehouse or gymnasium, or can be as small as a single lamp in a residential home.

The lighting fixture 103 is coupled to a control switch 105. In the illustrated embodiment shown in FIG. 1, the lighting fixture 103 is coupled to the control switch 105 via a hard wire connection. Alternatively, wireless connections could be used (e.g., IR, RF), however, this would require the lighting fixtures 103 to be capable of wireless communication.

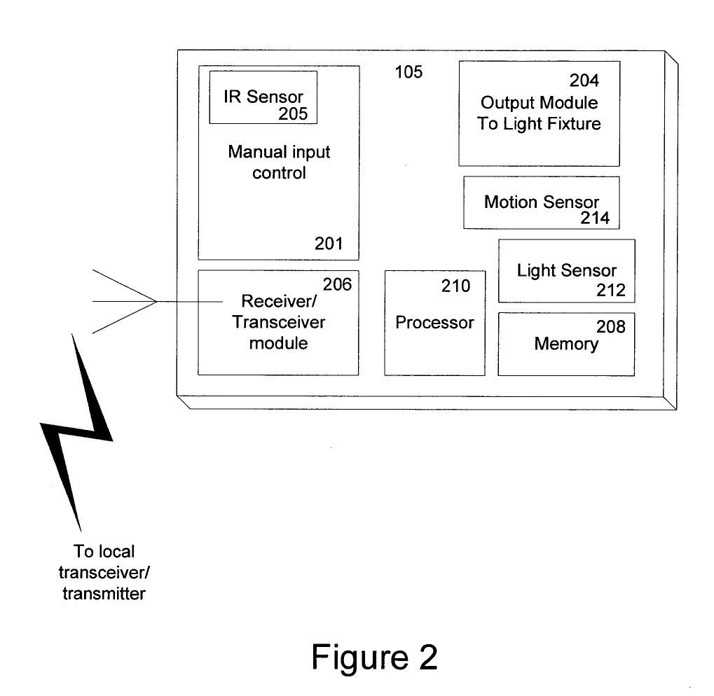

The control switch 105 is used to adjust the lighting level of the lighting fixture 103. The control switch 105 is an advanced dimmer switch that can allow for light fixture 103 to be in the full on position, off position, or any level in between the two. Referring to FIG. 2, an exemplary embodiment of the control switch 105 is illustrated. In the illustrated embodiment, the control switch 105 includes a manual input control 202. Examples of manual input controls include a knob that can be turned, an touchpad, a slide lever, etc. The manual input can allow a user located at the control switch 105 to adjust the lighting conditions. The control switch 105 can operate in manual mode completely independently of the remote access system. In an exemplary embodiment, the control switch 105 is a two wire switch that is connected in series with a load. The control switch 105 controls power output to the load (e.g., lighting fixture) by controlling the line impedance while creating proper synchronization of output power and input source (e.g., the AC voltage of the line). Software residing in microcontroller 210 is used to dynamically control impedance by controlling a power-generation device 212 within the unit (e.g., a MOSFET or an Insulated Gate Bipolar Transistor (IBGT)). A pulse width modulation technique is used allow the power-generation device 212 to drive the output power levels to the load. In an exemplary embodiment, the control switch 105 modulates at a frequency of approximately 62-65 KHz and can result in an frequency output to the load in the range of 10 KHz to 100 KHz, which allows for linear dimming of inductive or non-inductive loads of up to approximately 600 Watts. FIG. 4 illustrates a schematic drawing of one exemplary implantation of the control switch 105.

Control of the control switch 105 can be achieved in a variety of ways. The system can be configured to allow for manual control to override remote access, or conversely the system can be configured to allow for remote access to override manual control. For example, it may be desirous to allow manual control to override when one household member arrives home earlier than expected and wants to adjust the lighting conditions, while in other cases it may be desired to have remote access override, for example, when a parent wishes to keep their teenage son from turning on every light in the house before leaving. In one exemplary implementation, the control switch will allow manual input to override received remote instructions, but once a manual change is made, the system reverts to a waiting state in which any subsequent remote instructions override the manual selection until a manual input is applied again.

Additional manual control can be provided via an IR port 205 on the control switch. A handheld controller, similar to one used to control a television set, may be used to provide a control input to the IR port 205 of the control switch 105. While the handheld controller does not require the user to be directly located at the control switch, relatively close physical proximity (i.e., with line of sight) is required, and thus this means of adjusting the control switch is characterized as manual, as opposed to remote, control.

The control switch 105 also comprises a receiver/transmitter module 206, as well as an output 204. As discussed above, the output may comprise a port for hard wire connection to the lighting fixture 103, or, alternatively, a wireless connection to a wireless compatible lighting fixture 103. The receiver/transmitter module 206 receives remote access control instructions for adjusting the lighting fixture 103. In an exemplary embodiment, the receiver/transmitter module 206 includes the capacity to transmit information regarding its current status from the control switch 105 to the remote user. This allows for the remote user to determine existing lighting conditions. For example, if a manual user has increased the light intensity for a given room, this information will be sent to the remote user. In this way, a remote user will have sufficient information as to the current lighting status so as to determine if any changes are desired.

Additionally, the control switch 105 may include one or more memory modules 208. The memory modules allow for preset lighting conditions to be stored within the switch. For example, the switch may be able to be programmed to extinguish all connected lighting fixtures on Tuesday at 10 p.m. This information would be stored in the memory module. Timer information could be built into the control switch 105, or could be received remotely via the receiver/transmitter module 206. At 10 pm on Tuesday, the control switch would adjust the lighting conditions in accordance with the pre-programmed settings stored in the memory module.

Additional embodiments include providing the control switch 105 with a processing chip 210, a light sensor 212, and/or a motion sensor 214. The control switch 105 in such embodiments would have the capability of sensing current ambient lighting conditions or change in ambient lighting conditions via the light sensor 212 and adjusting the light intensity of a light fixture 103 accordingly. Additionally, the control switch 105 would have the capability of processing the information in accordance with pre-determined criteria (e.g. time of the day, day of the week, time of the year) via the microcontroller 210, and adjusting the lighting conditions accordingly. A motion sensor 214 can be used to determine the presence or absence of individuals in the area serviced by a lighting fixture, and the control switch 105 can adjust the light fixture 103 accordingly. The motion sensor 214 and/or light sensor 212 can be attached to the control switch 105, or, alternatively, can be located at any desired location and coupled to the control switch 105 via a wired or wireless connection. Additionally, the sensors could be coupled to the local transceiver 107 and communicated to the control switch 105 via a wireless link 106, as further described below.

The motion sensor 214 and the light sensor 212 are two types of sensors that may be incorporated into the system 100; however, alternative embodiments include using other sensing devices. For example, a sound sensor could be used in place of or in addition to the motion sensor 214 and light sensor 212. A sound sensor could be used to activate the lighting system 100 upon detection of a sound, or alternatively, more precise sound sensors could be used to allow the system to be controlled via voice commands. Such sensors are well known to one of skill in the art. Furthermore, the system 100 can utilize the microcontroller 210, memory 208, and receiver/transceiver module 206 on the control switch 105 to combine additional functions with lighting control. For example, individuals (e.g., employees of the facility where the system is installed) may be issued an RF transmitter (e.g., on a badge or a keychain). Control switch 105 can detect the presence of a particular individual by receiving an identifying RF transmission from the RF transmitter. This information can then be relayed via the system 100 to a user interface 302, using the communications network 300 as described below.

Referring again to FIG. 1, the control switch 105 is linked to a local transceiver 107. The local transceiver operates in a manner similar to the way a wireless router functions on wireless computer network. Signals are received at the local transceiver 107 from a remote location and are distributed locally via a local wireless link 106 to the control switch 105. For example, a series of control switches (e.g., one for each lighting fixture in the house) all reside within the reception area of local transceiver 107. When a signal containing instructions for controlling one or more lighting fixtures is received at the local transceiver 107 via one of several means more fully described below, the signal is transmitted via the wireless link 106 locally to the various control switches 105 to adjust the lighting as desired. This allows for a common point of communication through which all control switches can be linked to the communication link to the remote user. In an exemplary embodiment, the local transceiver 107 operates on an RF frequency band of 900 MHz to 2.4 GHz. This type of wireless connection is well known in the art, and is commonly used on devices such as cordless phones, wireless networks, etc. However, it is understood that other wireless links can be used, or, alternatively, wired links could be employed.

The local transceiver 107 is linked to a communication network 300 through which a remote user can access the local light fixtures via the local transceiver, or receive information provided by the local transceiver 107 regarding the current status of the lighting fixtures. In an exemplary embodiment, the communications network 300 comprises a user interface 302, a server 304 connected to a distributed network 306, and a transmission service provider 308.

User interface 302 can comprise a personal computer, laptop computer, Portable Digital Assistant (PDA), cellular phone, or any other device that allows a user access to the distributed network 306. In an exemplary embodiment, the distributed network 306 comprises the internet; however, the invention could be practiced using other networks such as an intranet, a Wide Area Network (WAN), a Local Area Network (LAN), etc.

In an exemplary embodiment, the user access a web service 308 via the user interface 302. The web service is a client based service such as PowerWeb that provides a Graphic User Interface (GUI) to allow the user to enter and receive data. The client based web service is coupled to a Network Operation Center (NOC) 307. The NOC 307 is the server side or back end side of the client/server relationship formed with the web service. The NOC 307 may reside on the same server on which the web service is operating, or alternatively, the NOC 307 may reside on a different server with the distributed network 306. The function of the NOC 307 is to perform any required processing/formatting of the information obtained via the web service interface. The NOC 307 converts the information originally provided by the remote user into a command signal in a form that can be transmit to the local transceiver 107. The NOC 307 transfers the command signal to a wireless communication service provider 308 (e.g., Verizon) for wireless transmission to the local transceiver 107. The actual transmission may be made via one or more wireless communication technologies, including but not limited to Global System for Mobile Communication (GSM), General Packet Radio Service (GPRS), wireless air interface standard (1XRTT), 2 way pager networks, or any cellular technology. Communication between the NOC 307 and the local transceiver is not limited to wireless communications and may also be effectuated via an internet channel, however it is generally believed that such communication via the internet could be less secure than the wireless techniques described above.

The command signal is forwarded via the service provider 308 to the local transceiver 107, which in turn directs the commands to the appropriate control switch 105 to provide the appropriate modifications to lighting fixtures 103.

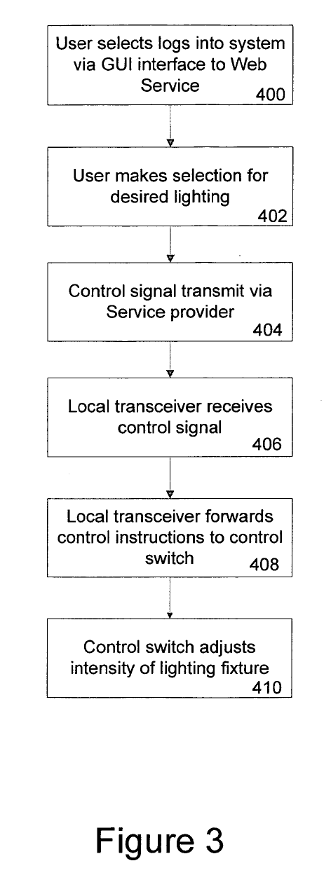

Referring now to FIG. 3, a flow chart illustrating the process by which a remote user adjusts a lighting fixture is shown. A user logs into the web service (step 400), which provides access via a GUI interface. Using the GUI interface, the user identifies himself or herself, for example, by entering a username and password. This tells the NOC what level of access to allow to the user (e.g., John Smith logs into the system and is provided access to John Smith's personal residence). Once access is established, the user interacts with the GUI interface receive information regarding the status of one or more lighting fixtures and selects any desired changes in the current lighting status (step 402). The information is processed by the NOC into a control signal and provided to the communication service provider. The control signal is transmitted via the appropriate communication channels to the local transceiver (step 404). The local transceiver receives the control signal (step 406) and re-transmits the control signal locally to the appropriate control switch (step 408). The control switch effectuates the change in lighting in accordance with the received instruction (step 410) thus completing the process.

The teachings of the present invention are not limited to utilizing control switches to control lighting, and may be applied to controlling other types of electrical equipment as well. For example, in the home environment, the techniques described herein can be expanded to control televisions, radios, coffee makers, heating units, etc., or in a commercial environment, the techniques described herein can be applied to controlling photocopy equipment, computers, printers, scanners, etc.

A variety of modifications to the embodiments described will be apparent to those skilled in the art from the disclosure provided herein. Thus, the present invention may be embodied in other specific forms without departing from the spirit or essential attributes thereof and, accordingly, reference should be made to the appended claims, rather than to the foregoing specification, as indicating the scope of the invention.

1. A system for controlling lighting environment, comprising:
a lighting fixture having multiple light intensity levels;
a control switch coupled to said fixture; and
a communications link between said control switch and a user interface;
wherein a user can control the light intensity level of said lighting fixture via commands entered into said user interface.

2. The system as set forth in claim 1, wherein said control switch further comprises:
means for receiving control commands; and
means for distributing said control commands to said lighting fixture.

3. The system as set forth in claim 2, wherein said means for receiving control commands include an infrared receiver.

4. The system as set forth in claim 2, wherein said means for receiving control commands include a radio frequency (RF) receiver.

5. The system as set forth in claim 2, wherein said control switch further comprises a transmitter.

6. The system as set forth in claim 1, wherein said control switch is coupled to a motion sensor.

7. The system as set forth in claim 1, wherein said control switch further comprises a photoelectric sensor for sensing the level of ambient lighting.

8. The system as set forth in claim 1, wherein said user interface comprises:
a graphical user interface (GUI) to a web service.

9. The system as set forth in claim 1, wherein said communications link comprises:
a client based web service for providing a GUI interface to a user, wherein said user inputs control information;
a server based Network Operations Center, wherein said control information provided to said web service is used to generate a control signal capable of transmission;
a transmission module for sending said control signal;
a transceiver for receiving said control signal and distributing said control signal to said control switch.

10. The system as set forth in claim 9, wherein said transmission module comprises a wireless service provider for transmitting said control signal in wireless format.

11. The system as set forth in 10, wherein said transmission is via cellular transmission.

12. The system as set forth in 10, wherein said transmission is via a pager network.

13. The system as set forth in 10, wherein said transmission is via Global System for Mobile Communication (GSM).

14. The system as set forth in 10, wherein said transmission is via General Packet Radio Service (GPRS).

15. The system as set forth in 10, wherein said transmission is via wireless air interface standard (1XRTT).

16. The system as set forth in claim 9, further comprising:
a transmitter;
a wherein said transceiver receives identifying signals from said transmitter to indicate the location of said transmitter.

17. A control switch for controlling a lighting fixture, wherein said control switch is coupled to said lighting fixture, said control switch comprising:
a RF receiver capable of receiving a control signal via an RF transmission.

18. The control switch as set forth in 17, wherein the control switch further comprises an infrared (IR) port for receiving an infrared control signal.

19. The control switch as set forth in 17, wherein the control switch further comprises a memory module.

20. The control switch as set forth in 17, wherein the control switch further comprises a processor.

21. The control switch as set forth in 17, wherein the control switch is coupled to a light sensor.

22. The control switch as set forth in 17, wherein the control switch is coupled to a motion sensor.
